(19) United States
(12) Patent Application Publication
(10) Pub. No.: US 2019/0331312 A1
(43) Pub. Date: Oct. 31, 2019

(54) BREATHABLE ELEMENT FOR LIGHTING OF VEHICLE

(71) Applicant: JUTE INDUSTRIAL CO., LTD., Taichung City (TW)

(72) Inventor: SHIH-CHIEH WEI, TAICHUNG CITY (TW)

(21) Appl. No.: 15/962,586

(22) Filed: Apr. 25, 2018

(51) Int. Cl. F21S 45/30; F21S 45/10

(52) U.S. Cl. CPC F21S 45/30; F21S 45/10

(57) ABSTRACT

A breathable element for lighting of vehicle includes a housing, a cylinder, and a breathable film. The housing has a peripheral wall and a bottom to enclose a receiving room. The peripheral wall has a positioning structure at the opening end. The bottom has a protruding structure. The cylinder includes an inner cylinder and an outer cylinder. The inner cylinder is connected with the outer cylinder via plural connection portions arranged spacedly. An air channel is defined between any two adjacent connection portions and extends axially. The inner cylinder is axially formed with a channel. The cylinder abuts against the protruding structure. The cylinder is received in the receiving room so that the channel communicates the air channel. The cylinder is prevented from leaving the housing freely by the positioning structure. The breathable film is disposed on an end of the inner cylinder inside the housing.

### BACKGROUND OF THE INVENTION

### Field of the Invention

The present invention relates to a breathable element.

### Description of the Prior Art

Ventilation is important to electronic devices or machines to ensure operating normally. However, dust or water outside may enter the devices via the ventilation holes to damage the devices or shorten its service life.

Thus, breathable film is usually disposed on the ventilation hole to allow gas to pass through but block liquid or solid in order to prevent water or dust from entering the devices. However, the film is easy to adsorb water and dust to be clogged. In addition, the exposed film is easy to damage.

### SUMMARY OF THE INVENTION

The main object of the present invention is to provide a breathable element for lighting of vehicle to protect machines or electronic devices from water but good in ventilation.

To achieve the above and other objects, a breathable element for lighting of vehicle of the present invention includes a housing, a cylinder, and a breathable film. The housing is cylinder-shaped and has a peripheral wall and a bottom. The peripheral wall and the bottom enclose a receiving room. The peripheral wall is formed with a positioning structure at an end thereof remote from the bottom. The positioning structure is protruded radially and inward. The bottom has at least one protruding structure. The cylinder is made of elastic material and includes an inner cylinder and an outer cylinder. The inner cylinder is located in the outer cylinder and connected with the outer cylinder via a plurality of connection portions arranged spacedly. An air channel is defined among any two adjacent the connection portions, the inner cylinder, and the outer cylinder. The air channel extends along an axial direction of the cylinder. An end of the inner cylinder is an engaging portion. The inner cylinder is axially formed with a channel. An end of the cylinder remote from the engaging portion abuts against the protruding structure, and the cylinder is received in the receiving room so that the channel communicates the air channel due to the protruding structure. The cylinder is positioned by the positioning structure to be prevented from leaving the housing freely. The breathable film is disposed on an end of the inner cylinder remote from the engaging portion. Air is able to enter the channel via the breathable film, but liquid is blocked by the breathable film.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a stereogram of the present invention at another angle;

FIG. 4 is a breakdown drawing of the present invention at another angle;

FIG. 5 is a cross-section breakdown drawing of the present invention;

FIG. 6 is a cross-section drawing of the present invention;

FIG. 7 is an illustration of the present invention.

### DETAILED DESCRIPTION OF THE PREFERRED EMBODIMENTS

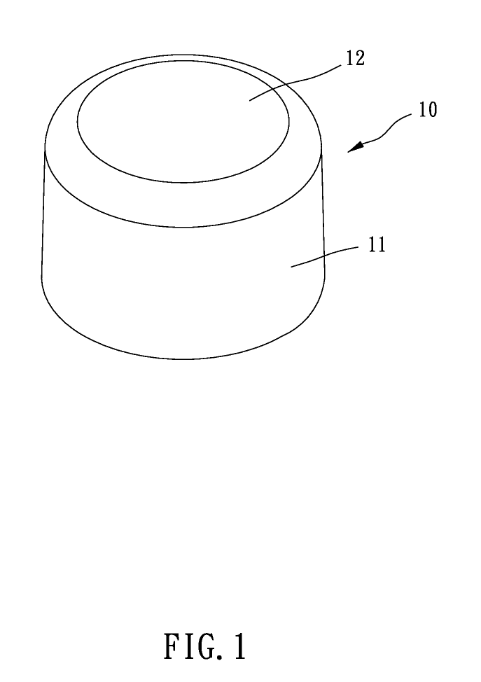

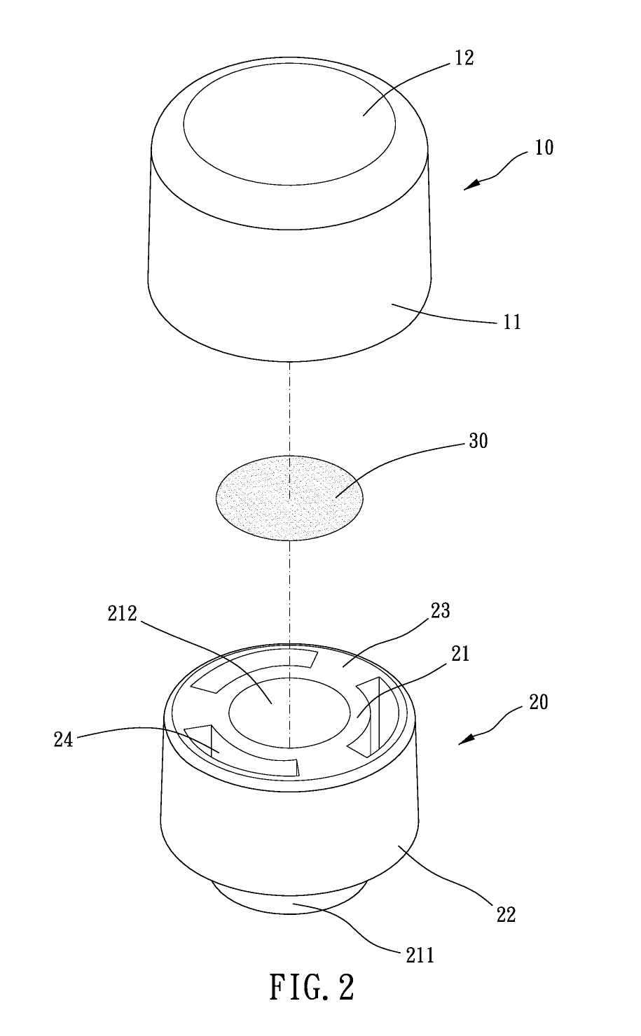

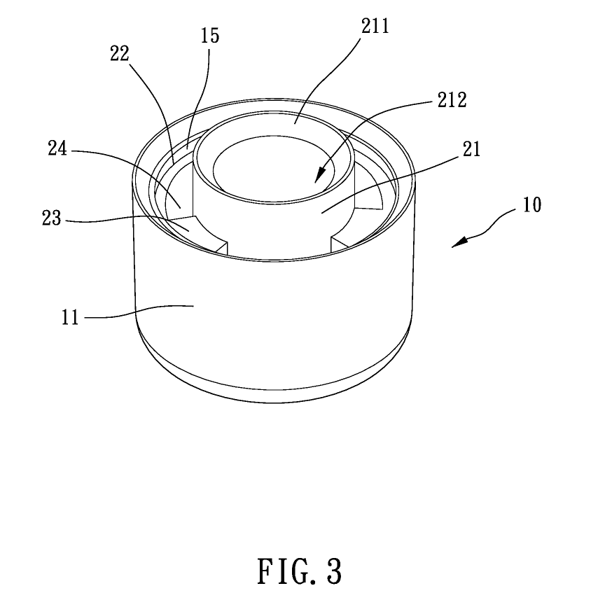

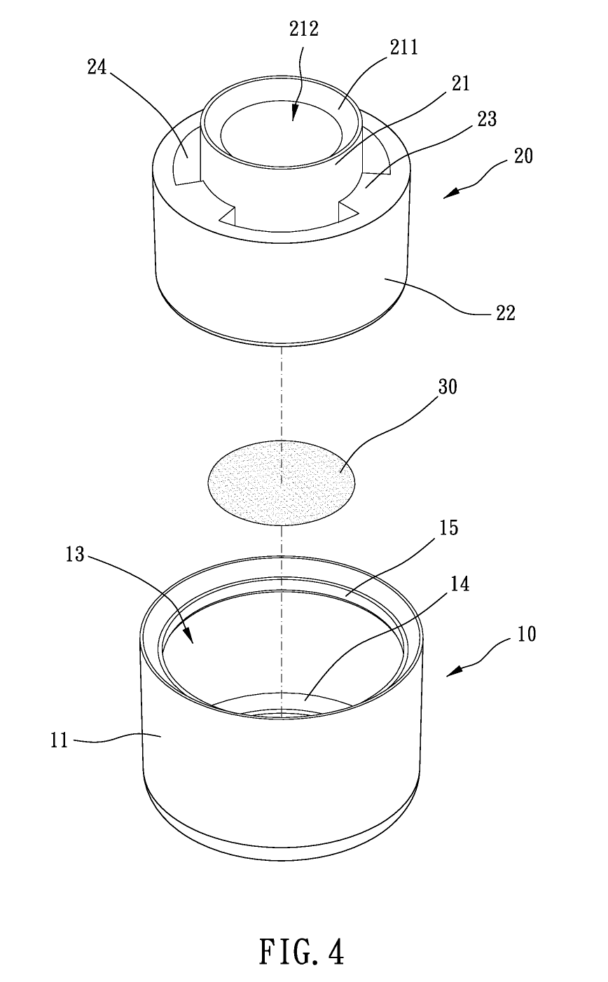

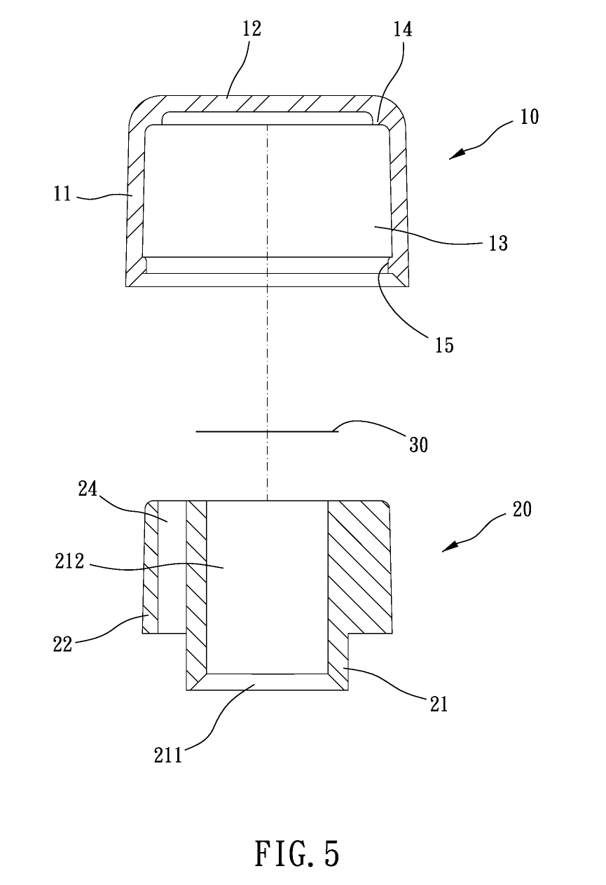

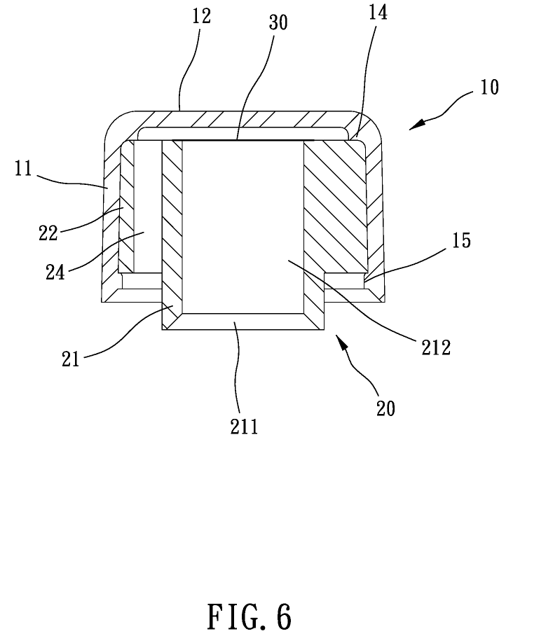

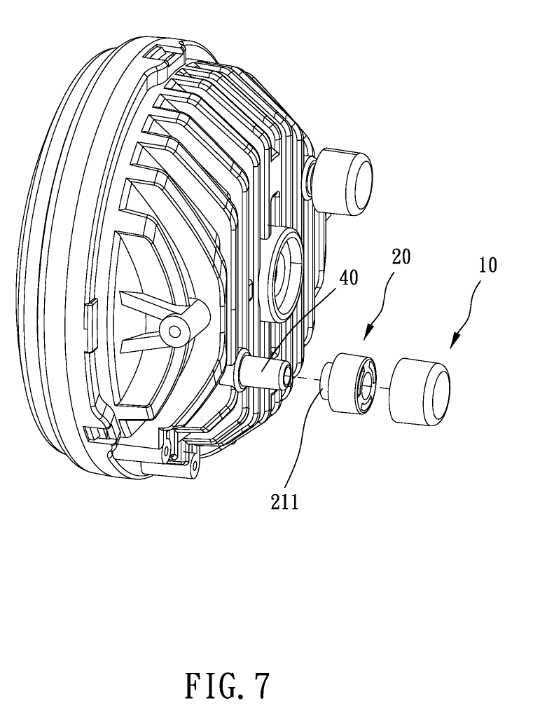

Please refer to FIG. 1 to FIG. 7, the breathable element for lighting of vehicle of the present invention includes a housing 10, a cylinder 20, and a breathable film 30.

The housing 10 is cylinder-shaped and has a peripheral wall 11 and a bottom 12. The peripheral wall 11 and the bottom 12 enclose a receiving room 13. The peripheral wall 11 is formed with a positioning structure 15 at an end thereof remote from the bottom 12. The positioning structure 15 is protruded radially and inward. The bottom 12 has at least one protruding structure 14. The cylinder 20 is made of elastic material and includes an inner cylinder 21 and an outer cylinder 22. The inner cylinder 21 is located in the outer cylinder 22 and connected with the outer cylinder 22 via a plurality of connection portions 23 arranged spacedly. An air channel 24 is defined among any two adjacent the connection portions 23, the inner cylinder 21, and the outer cylinder 22. The air channel 24 extends along an axial direction of the cylinder 20. An end of the inner cylinder 21 is an engaging portion 211. The inner cylinder 21 is axially formed with a channel 212. An end of the cylinder 20 remote from the engaging portion 211 abuts against the protruding structure 14, and the cylinder 20 is received in the receiving room 13 so that the channel 212 communicates the air channel 24 due to the protruding structure 14. The cylinder 20 is positioned by the positioning structure 15 to be prevented from leaving the housing 10 freely. The breathable film 30 is disposed on an end of the inner cylinder 21 remote from the engaging portion 211. Air is able to pass through the breathable film 30, but liquid is blocked by the breathable film 30.

In the present embodiment, the positioning structure 15 is an annular flange protruded radially and surrounding the housing 10 circumferentially. The protruding structure 14 is a stepped portion formed at a juncture of the peripheral wall 11 and the bottom 12 and surrounding the housing 10 circumferentially. Preferably, an inner diameter of the stepped portion is larger than an outer diameter of the inner cylinder 21 but smaller than an outer diameter of the outer cylinder 22. Besides, an outer diameter of the outer cylinder 22 is equal to or slightly larger than an inner diameter of the housing 10. Thus, the elastic cylinder 20 can be positioned in the housing 10 by tight-fit. The engaging portion 211 is located outside the outer cylinder 22. In addition, the cylinder 20 preferably includes three the connection portions 23 and three the air channels 24. A circumferential length of each of the connection portions 23 is smaller than a circumferential length of each of the air channels 24.

In use, the engaging portion 211 is inserted into a connector of a device 40. The interior of the device 40 communicates the exterior via the channels 212, the receiving room 13, and the air channels 24. However, the channels 212 are disposed with the breathable film 30, so only gas can move between the interior and the exterior of the device 40. Liquid is blocked from entering the interior of the device 40 from the exterior. Therefore, the present invention is good at water-proofing and ventilation.

Specifically, the outer surface of the outer cylinder 22 contacts the inner surface of the housing 10 completely, so larger friction is provided to position the cylinder 20 inside the housing 10. Thus, the housing 10 is difficult to fall off from the cylinder 20.

Thereby, the present invention has a simple structure and easy installation to protect electronic devices or machines from water but good at ventilation. In addition, the breathable film is protected by the housing so that the present invention is more durable.

What is claimed is:

1. A breathable element for lighting of vehicle, including:
a housing, being cylinder-shaped and having a peripheral wall and a bottom, the peripheral wall and the bottom enclosing a receiving room, the peripheral wall being formed with a positioning structure at an end thereof remote from the bottom, the positioning structure being protruded radially and inward, the bottom has at least one protruding structure;
a cylinder, made of elastic material and including an inner cylinder and an outer cylinder, the inner cylinder being located in the outer cylinder and connected with the outer cylinder via a plurality of connection portions arranged spacedly, an air channel being defined among any two adjacent the connection portions, the inner cylinder, and the outer cylinder, the air channel extending along an axial direction of the cylinder, an end of the inner cylinder being an engaging portion, the inner cylinder being axially formed with a channel, an end of the cylinder remote from the engaging portion abutting against the protruding structure and the cylinder being received in the receiving room so that the channel communicates the air channel due to the protruding structure, the cylinder being positioned by the positioning structure to be prevented from leaving the housing freely;
a breathable film, disposed on an end of the inner cylinder remote from the engaging portion, air being able to pass through the breathable film, liquid being blocked by the breathable film.

2. The breathable element for lighting of vehicle of claim 1, wherein the positioning structure is an annular flange protruded radially and surrounding the housing circumferentially.

3. The breathable element for lighting of vehicle of claim 1, wherein the protruding structure is a stepped portion formed at a juncture of the peripheral wall and the bottom and surrounding the housing circumferentially.

4. The breathable element for lighting of vehicle of claim 3, wherein an inner diameter of the stepped portion is larger than an outer diameter of the inner cylinder but smaller than an outer diameter of the outer cylinder.

5. The breathable element for lighting of vehicle of claim 1, wherein the cylinder is made of plastic.

6. The breathable element for lighting of vehicle of claim 5, wherein an outer diameter of the outer cylinder is equal to or slightly larger than an inner diameter of the housing.

7. The breathable element for lighting of vehicle of claim 1, wherein the engaging portion is located outside the outer cylinder.

8. The breathable element for lighting of vehicle of claim 1, wherein the cylinder includes three the connection portions and three the air channels, a circumferential length of each of the connection portions is smaller than a circumferential length of each of the air channels.
